(19) United States
(12) Patent Application Publication
(10) Pub. No.: US 2019/0318392 A1
(43) Pub. Date: Oct. 17, 2019

(54) Advertising System and Method

(71) Applicant: Mediagistic, Inc., Tampa, FL (US)

(72) Inventors: Brantley Smith, Lutz, FL (US); Peter Guenther, Dade City, FL (US)

(73) Assignee: Mediagistic, Inc., Tampa, FL (US)

(21) Appl. No.: 16/379,235

(22) Filed: Apr. 9, 2019

Related U.S. Application Data
(60) Provisional application No. 62/657,375, filed on Apr. 13, 2018.

(51) Int. Cl. G06Q 30/02; G06Q 50/00

(52) U.S. Cl. CPC G06Q 30/0275; G06Q 50/01; G06Q 30/0249

(57) ABSTRACT

An advertising system includes at least one source of dynamic data (e.g., weather, sport scores, airline prices/availability . . . ) and an advertisement (e.g., an advertisement for a product or service). Software running on a processor receives the dynamic data from the at least one source of dynamic data, analyzes the dynamic data as related to the advertisement, and determines a priority for the advertisement. The software then controls placement of the advertisement based upon the priority. In some embodiments, the advertisement is modified based upon the dynamic data and/or includes some part of the dynamic data.

### CROSS-REFERENCE TO RELATED APPLICATION

This application claims the benefit of U.S. provisional application No. 62/657,375 filed on Apr. 13, 2018, the disclosure of which is incorporated by reference.

### FIELD

This invention relates to the field of advertising and more particularly to a system for efficient allocation of advertising funds.

### BACKGROUND

We are all exposed to advertising on a daily, hourly, by-the-minute basis. We drive down the road and see signs, billboards, electronic video billboards, logos on vehicles, advertisements on trucks and cars, etc. We receive tons of junk mail full of advertisements. Our phones often ring, noting the arrival of text messages and calls from marketers. Every time we look at our smartphones or computers, we receive messages about why we should be interested in one product or another. We can't turn on the television without seeing advertisements for products and/or services. Every time we use a search engine or access web pages, we get to see advertisements. Advertisements are everywhere.

All of these advertisements come from somewhere and they are not free. Marketers pay for having their advertisements on fixed billboards, for time on an electronic billboard, for each email or text message that is sent, for television time on a specific program, for each time an advertisement is displayed (e.g. in response to a search or in a web page), for salaries to make calls or send text messages, for each time an advertisements is accessed (clicked on), etc. All of this costs money and companies that sell products and/or services are sensitive to the costs for advertising, usually setting up advertising (or marketing) budgets.

So, how do these companies know if their advertising budgets are spent wisely and how effective there advertising is? A company advertising during a final football game in early February will spend a huge amount for a 30 second television commercial, but how does that company know if this commercial resulted in more people buying pizza from that company as opposed to the number of people buying pizza from that company is the commercial didn't air? Most of the value is estimated based upon the rating of the program (e.g. number of viewers). It is believed that a certain percentage of viewers will see the commercial and order the product or service.

For Internet advertising (e.g. by way of search engines, appearances on web pages, links in messages), the advertisers have additional feedback on the effectiveness of each advertisement. For each advertisement, statistic are captured indicating the number of times each advertisement is viewed (impression) and each time that advertisement is selected, typically called click-through. Click-through rates generally reflect the effectiveness of the advertisement, though it is not certain how much product or service the user purchases based upon clicking on the advertisement. For example, an advertisement having a click-through rate of 10% is viewed as more effective than one having a click-through rate of 2%. In some instances, the advertiser pays for each view, called an impression, and an additional amount for each click-through.

To further complicate the world of advertising, search engines often present results based upon several criteria. Not just relevance to the search string, but often relevance to what an advertiser will pay per appearance in a search result. Yes, the appearance of results from search engines is influenced by money. For example, a search for a “patent attorney” on a popular search engine from Pinellas County returns three advertisements (marked as “ad”), each for firms that are not local (Coral Springs, Fla.; Orlando, Fla.; and Miami Fla.). These three results are displayed because each of these firms paid money for the search engine to increase the priority of these advertisements in search results. Next, four patent law firms from the area are displayed in a specific order. The first local firm displayed is local, but is also an advertisement (marked by “ad”) and the next three are also local but are not advertisements. The first local advertisement is above the other four, primarily because that firm also paid to increase the priority of this advertisement in search results. The remaining three results have some priority based upon a very complicated algorithm used by the search engine related to user ratings, number of total ratings, etc.

Placement, priority, and budget all present a challenge to advertisers (marketing managers), in that, there is a budget for advertising dollars and a goal in sales, but these marketing managers must make assumptions as to the best place to spend their advertising dollars, creating advertising content that is appealing to the targeted customer, placing that content in the best locations, and optimizing such placement to remain within budget. There are so many variables that these marketing managers must consider when determining how to best spend their advertising dollars. Should they spend on television advertisement? Should they advertise based upon search results? Should they advertise on certain popular web pages (e.g. on a nation-wide newspaper's web page, on a news service web page, on a travel consolidator's web page . . . )?

There is a large portion of advertisement that wastes the advertiser's budget. For example, placing a fixed billboard advertisement for snow tires for the month of March and there is no snow that month, or a fixed advertisement for flights to a place that just had a natural disaster or when there are no airline seats available.

So, how does a marketing manager decide how and when to present certain advertising content and at what cost? Then, once decided, how does the marketing manager react to changes in market influencers (e.g. weather, costs, availability, event outcomes)? Typically, the marketing manager sets up a marketing campaign, runs the marketing campaign for a period of time such as a few weeks or a month, monitors sales, then, if needed, modifies the marketing campaign for the subsequent period of time. During when the marketing campaign runs, the marketing manager does not typically modify parameters. For example, if the marketing manager bids $0.0001 per time an advertisement appears on a first page of search results, it remains that for the entire period.

Further, some marketing campaigns include features that are dependent upon an outcome of a sporting event. For example, if a team wins or hits a home run in the second inning, there is a special price for a product such as two pizzas for $10.00. These marketing campaigns run independent of the sporting event, in that, the advertisements run (e.g. Internet, television, or radio advertisements), typically before, but often during the event, independent of the outcome. You might see the advertisement in the 6^{th} inning when not runs were hit in the 2^{nd} inning or when the score is 15 to zero.

What is needed is a system that will dynamically allocate advertising budgets based upon dynamic data.

### SUMMARY

In one embodiment, an advertising system is disclosed including at least one source of dynamic data (e.g., weather, sport scores, airline prices/availability . . . ) and an advertisement (e.g., an advertisement for a product or service). Software running on a processor receives the dynamic data from the at least one source of dynamic data, analyzes the dynamic data as related to the advertisement, and determines a priority for the advertisement. The software then controls placement of the advertisement based upon the priority.

In another embodiment, a method of advertising is disclosed including receiving dynamic data from a data source and determining a priority based upon the dynamic data and a marketing campaign. A frequency of presentation of an advertisement is then adjusted based upon the priority.

In another embodiment, program instructions tangibly embodied in a non-transitory storage medium that have at least one instruction configured to implement a system for advertising are disclosed. The at least one instruction includes computer readable instructions executed by a processor of a computer for causing the computer to request dynamic data from at least one data source over a communications network and computer readable instructions executed by the processor for causing the computer to calculate a priority based upon the dynamic data. The computer readable instructions executed by the processor then cause the computer to control a frequency of presentation of an advertisement based upon the priority.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a data relation diagram of a system for advertising.

FIG. 2 illustrates a connected diagram of the system for advertising.

FIG. 3 illustrates a second connected diagram of the system for advertising.

FIG. 4 illustrates an exemplary search result with advertising.

FIG. 5 illustrates an exemplary web page with advertising.

FIG. 6 illustrates an exemplary message with advertising.

FIGS. 6A and 6B illustrate source advertisements merged with dynamic data.

FIG. 7 illustrates an exemplary television/video advertisement.

FIG. 8 illustrates a connected diagram of the system for advertising with various data sources.

FIG. 9 illustrates a sample marketing campaign of the system for advertising.

FIG. 10 illustrates a second sample marketing campaign of the system for advertising.

FIG. 11 illustrates a third sample marketing campaign of the system for advertising.

FIG. 12 illustrates a sample program flow of the system for advertising.

FIG. 13 illustrates a schematic of a typical computer system as used by the system for advertising.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Throughout this description, the term “dynamic data” refers to data that is current and changing, such as weather, events, sporting event outcomes, prices, etc. The term “impression” relates to the display or utterance (e.g. radio) of an advertisement or brand name. The term “click-through” relates to an action of a potential buyer of selecting the advertisement.

Throughout this description, the term “maximum bid” refers to a dollar amount an advertiser is willing to pay for a click-through on a search result; the term “daily budget” refers to the total dollar amount an advertiser is willing to spend on search engines for a specific marketing campaign; the term “bid cap” refers to a dollar amount an advertiser is willing to pay for a click-through on a social media page; and the term “lifetime budget” refers to the total dollar amount an advertiser is willing to spend on social media during the life-span of a specific marketing campaign.

In the past, marketing managers allocated parts of their marketing budget to advertising. For example, if a marketing manager had $10,000 per month in budget to market a widget, the marketing manager allocates a portion of this to television advertisements (e.g. run advertisement five times per day on TV channel 5 each day of the month), another portion of this to billboards (e.g. place an advertisement on three billboards in New York City for the entire month), and another portion of this to internet advertising (e.g. pay $0.0001 to elevate this product to the top of search results). For the most part, much of this is static, as at the beginning of the month, fees are paid for the advertisements. As time goes on, if the marketing manager sees fit, the marketing manager has the ability to increase/decrease the cost of internet advertising, but this is not typical unless something severe happens such as the company decides to drop the product or sales plummet, etc.

Prior systems did not take into account events or conditions that relate to the product being sold. For example, if the product is an airline ticket from point-A to point-B, advertising is constant whether there is one seat left on that flight or 50. Further, if point-B is a warm-weather destination, there is no change in advertising, even if the weather at point-A is freezing. In another example, in the past, advertisements for a sporting event are run at a constant frequency, even though there are no available seats remaining.

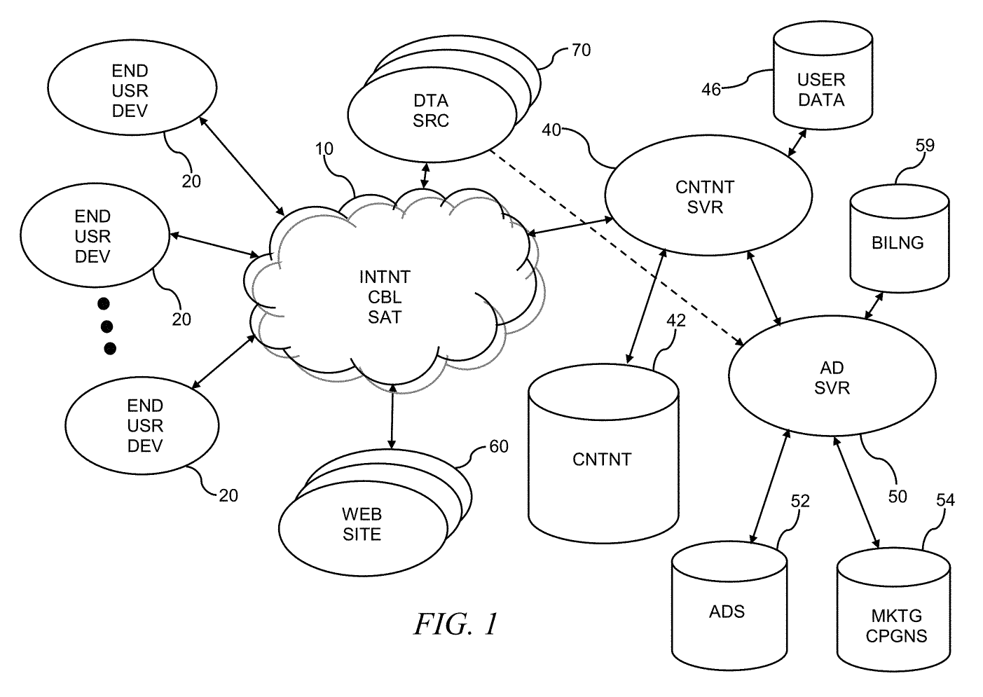

As shown in FIG. 1, an exemplary data flow diagram of the system for advertising is shown. As an example, advertising is delivered to a user through a network 10 (e.g. Internet, cable TV network, Satellite network), though any type of advertising is anticipated. In this example, Internet or television advertising is used as an example that clearly describes the present invention, though any type or form of dynamic advertising is anticipated including, but not limited to, television advertising, radio advertising, advertising by phone calls, advertising by message (e.g., email, text), advertising by signage (e.g. electronic billboards), etc. Note that dynamic advertising is any type of advertising that provides the ability to change (e.g. increase, decrease, defer, start, stop) quickly. An electronic billboard is an example of dynamic advertising as it is reasonable to increase/decrease/suppress a specific advertisement in a matter of seconds. A traditional billboard is an example of static advertisement as it is not reasonable to make changes to a specific advertisement on a traditional billboard without sending a crew to change the advertisement.

In FIG. 1, there are several user devices 20 interface to a network 10. In some embodiments, the user devices 20 are, for example, computers such as desk-top computers, notebook computers, smartphones, tablets, smartwatches, etc. In some embodiments, the network 10 is a cable or satellite network and the user devices 20 are televisions.

In general, users operate the user devices 20 and browse to web sites looking for content such as to retailer web sites for shopping, airline web sites for buying airline tickets, news/weather web sites for the latest news or weather, search services, entertainment content (e.g. movies, music), data web sites for current information regarding stocks, currencies, etc. In the television examples, users operate the user devices to watch content such as a television show. The content in this case is video content and the content provider is typically a cable television provider, a satellite television provider, an internet television provider, etc.

The web sites or providers that provide this content are collectively described as content servers 40 in FIG. 1. Each content server 40 has access to a storage of content 42 (e.g. data such as stock quotations, digitized movies, digitized music, news articles). This is all well-known in various forms, all of which are included herein. The delivery mechanisms are anticipated to be any know delivery mechanism, but the basic premise is the same, money is made by the content providers by presenting advertising content to the users.

Although slightly different, electronic billboards present content, but the content is typically 100% advertisement content. The electronic billboards are connected to a content server 40, but there is rarely any other content displayed on the electronic billboards other than advertisements.

Each time the user accesses content, for most content providers, advertising is included with what is returned to the user. This advertising is often a major source of revenue for the content providers and many content providers provide their content for the sole purpose of earning advertising revenue.

In the example shown, the content server receives advertising from an advertising server 50. The advertising server 50 has access to advertisements 52. The advertising server 50 provides advertisements to the content server 40 based upon, for example, marketing campaigns 54. An example of a marketing campaign is “present advertisement AAA 20 times per day” or “when a search for pizza is made, bid $0003 for the highest advertisement placement of advertisement BBB to be returned in the search results.” There are many ways for the marketing manager to control how and when an advertisement is presented.

The advertising server 50 also manages billing. For example, in the above example, if a search was made for “pizza,” then the advertiser that requested the advertisement BBB be placed is billed $0.0003 and the billing is tracked in, for example, a billing file 59 for later generation of an invoice for that advertiser. Note that, in some embodiments, the content server 40 and the advertising server 50 are implemented in a single processor or group of processors.

In many advertisements, the goal is brand recognition and increased sales. Often, increased sales occur as a direct result of the advertisement being presented, or the “impression.” In some cases, this sale is made because someone calls a phone number presented in the advertisement, while in some cases, this sale is made by the user clicking on the advertisement (or other form of selection such as voice, tapping, etc.) called “click-through.” Often, upon the user clicking through, an additional charge is applied to the billing for that advertiser.

The result of the click-through is often that the user visits the web site 60 of the advertiser. For example, when the advertisement for pizza BBB is presented and the user clicks on that advertiser, the user is redirected to the web site 60 of the advertiser and presented with the opportunity to order pizza at the advertised price or configuration (e.g. two pepperoni pizzas for $10.99).

So far, what has been described is generally how much of current advertising operates. The advertisers provide advertisements 52 that are placed into or between content according to marketing campaigns 54. This system works, but it is not optimal as the placement of advertisements 52 is totally independent of dynamic data. Dynamic data is data that changes, typically quite often, as opposed to static data that rarely changes. Consider data such as the age when you are allowed to drink, the average age of people living in Florida, the average distance between pharmacies, etc. These data may change over time, but not on a daily basis, yet such data is important to advertisers when deciding on their marketing campaigns 54. If the average age of people in Florida is 52, then advertising campaigns for certain medications might target Floridians more than those in another state in which the average age is 41. Again, being that this data is static, there is no need to change a marketing campaign in the middle of the month as these data are likely to be the same or insignificantly different from the beginning of the month.

Dynamic data is available in from many sources. A simplistic example is weather. Is the weather below average, cold and snowy, or is the weather above average and sunny? This data changes on a daily, even hourly rate. Now, having the current weather and possibly a prediction for the next few days, an advertising manager has an additional tool. If the weather below average, cold and snowy in Chicago and the weather forecast in St. Lucia is sunny in the 80s, a marketing campaign for vacations in St. Lucia will have better results than if the weather in Chicago is sunny and in the 60s. Now add in data regarding flight seating capacity, cost per seat, and hotel occupancy rates to better hone the decision as to whether to advertise. For example, if there are no rooms or no seats, it is a waste of time to advertise. In another example, if the airfare is $899.00, less will book, but if the airfare is $599.00, more will book. Having the price of airfare known, it is now possible to insert the price of the airfare into the advertisement.

In another example, if a blizzard is predicted, a HVAC company will want to advertise furnace tune-ups so you don't have a failure during the upcoming blizzard or clothing companies will want to advertise cold-weather clothing such as coats and sweaters, while advertisements for such are not necessary in average or above average temperature days.

In another example, a hardware superstore has an exterior surfacing division. In the past, marketing campaigns were set sixteen days in advance with no relevance to the weather conditions. This sometimes causes problems should a hurricane or tornado occur, as the hardware superstore does not want to appear to be predatory on those suffering losses due to such storms. By having dynamic data, if there is no rain predicted, the marketing campaign is pared back. If rain is predicted (e.g. people's roofs leak), the marketing campaign is increased. If torrential rain is predicted, the marketing campaign is further increased. If a major storm occurs (e.g. tornado or hurricane), the marketing campaign is halted.

The net result is advertisements that are directly controlled by dynamic data without requiring daily or hourly “tweaking” by the marketing managers. In such, a priority of each advertisement is increased or decreased based upon the dynamic data. If a snow storm is predicted, the priority of an advertisement for snow shovels is increased, whereas if it is sunny or raining, the priority of this advertisement for snow shovels is decreased. The priority dictates the frequency or placement of the advertisements. For example, a higher priority results in a higher bid for click-throughs on an advertisement or a higher frequency of delivery of an advertisement, while a lower priority results in in a lower bid for click-throughs on an advertisement or a lower frequency of delivery of an advertisement, with a zero priority suppressing such advertisement.

To accomplish this, data sources 70 are consulted by the advertising server 50 to determine a priority at which advertisements get airtime and/or to insert some or all of this dynamic data into the actual advertisements, automatically, without direct interaction with marketing managers. The data sources 70 include any dynamic data sources such as local news, other news, weather, web sites that track commodity prices (e.g. gasoline prices), airline seat availability and price databases, sporting event schedules, sporting event scores/outcomes, television schedules (e.g. TV listings), appearances by certain people in programming, published pollen/mold counts and UV indexes, metrological events, tides, and what other advertisers are advertising. The later provides ability to adjust a marketing campaign to benefit from traffic created by other's advertisements.

The ability to adjust a marketing campaign to benefit from traffic created by other's advertisements requires a specialized data source called a media monitor that monitors various media for contents. For example, in the case of live television, the media monitor monitors all channels and reports mentions of certain words, phrases, names, etc. In this example, suppose all television stations are monitored by the media monitor and on one or more channels, there is an advertisement for “pizza” or there is a movie in which everybody is eating pizza, the marketing campaign has a feature to increase the priority, and hence, the frequency of advertisements for their pizza chain for fifteen minutes after this event. Therefore, as people are watching the program (or commercial of another company) and go to their browser, since they are now hungry for pizza, these people see the advertisement from the marketing campaign and, statistically, some of those people will by pizza from there.

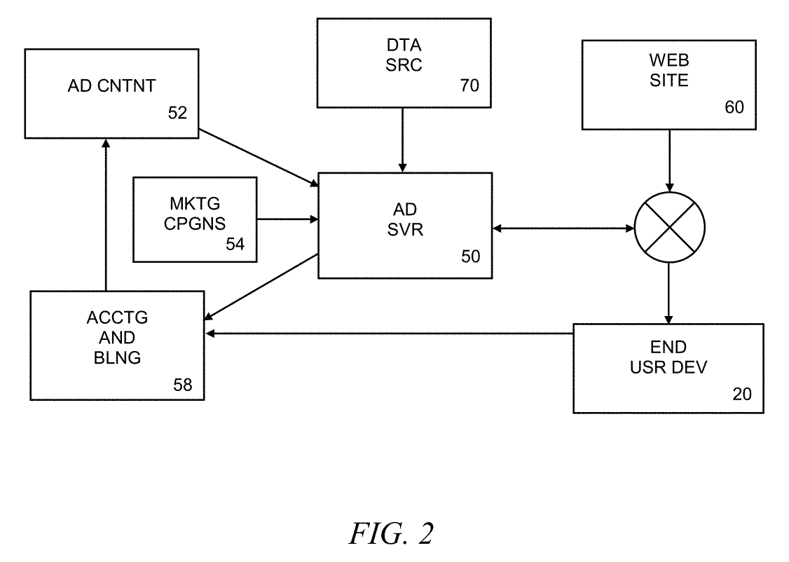

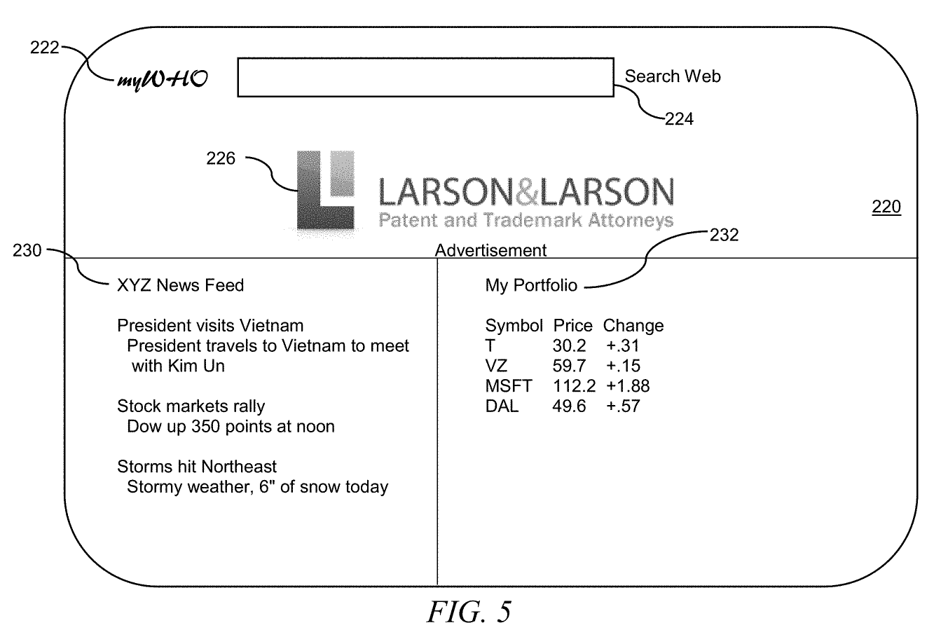

Referring to FIG. 2, a connected diagram of the system for advertising is shown. In this example, the user device 20 is accessing content, for example, viewing a web page such as the web page 220 shown in FIG. 5. The web page 220 is provided by a web site 60, for example, from a news service, weather service, data provider, product catalog, auction site, etc. Many such web sites 60 obtain money by advertising. In FIG. 2, the content from the web site 60 is mixed with one or more web page advertisements 126 that are provided from an advertising server 50. The advertising server 50 receives content from a store of advertisements 52 (e.g. a database of advertisements, a remote server having advertisements . . . ). These advertisements 52 are provided by marketing companies and each time this web page advertisements 226 is presented to a user device 20 (e.g. an impression), the advertising server 50 bills for the impression by, for example, writing an entry into an accounting and billing file 58. Further, if a user at the user device 20 reads the web page advertisements 226 and selects the web page advertisements 226 (e.g. clicks on the advertisement, taps on the advertisement . . . known as a click-through), in some embodiments, additional billing is written to the accounting and billing file. In this, the marketing company pays additionally when the user visits their web site as a result of the web page advertisement 226.

In the pasts, various algorithms were used to determine which advertisement(s) to present on the web page 220. In some prior systems, data on the user device 20 or browsing history of the user was used to improve selection of advertisements. For example, if the user just finished searching from new cars, then the advertising server 50 selects new vehicle related advertisements.

In the present invention, the advertising server 50 consults marketing campaigns 54 and one or more data sources 70 to aid in the prioritization (and therefore selection) of the advertisements. For example, if the advertising server 50 determines it is time to push an advertisement from marketing company A, then the advertising server 50 consults a marketing campaign 54 of marketing company A. In this example, if the marketing campaign 54 of marketing company A indicates to present advertisement A-001 only when the weather indicates rain is in the forecast for the next 24 hours, then the advertising server 50 contacts a data source 70 having the weather and determines if rain is in the forecast and, if so, the advertising server 50 increases the priority for advertisement A-001 (presents advertisement A-001 more often), otherwise, the advertising server 50 looks to the next entry in the marketing campaign 54 or the next marketing campaign 54 for a different advertisement for placement. In this way, the marketing company is able to control which advertisements 52 (advertisement content) are displayed, and under what conditions.

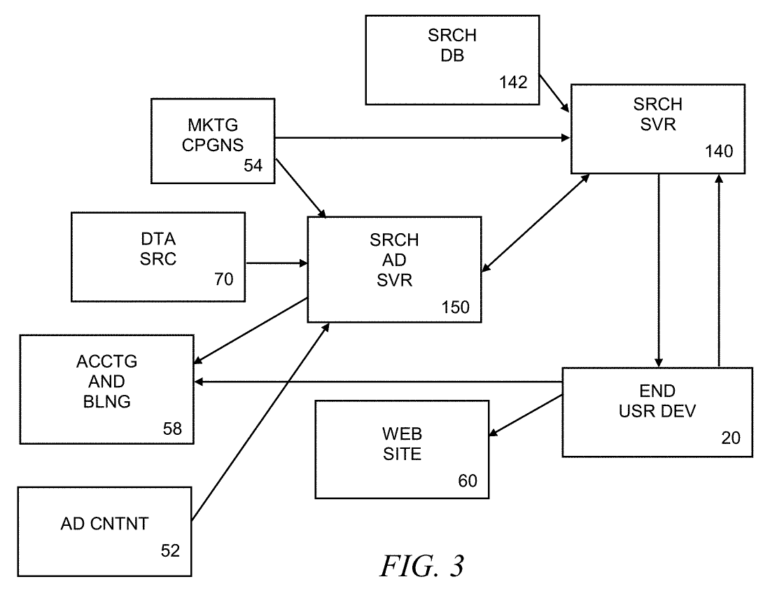

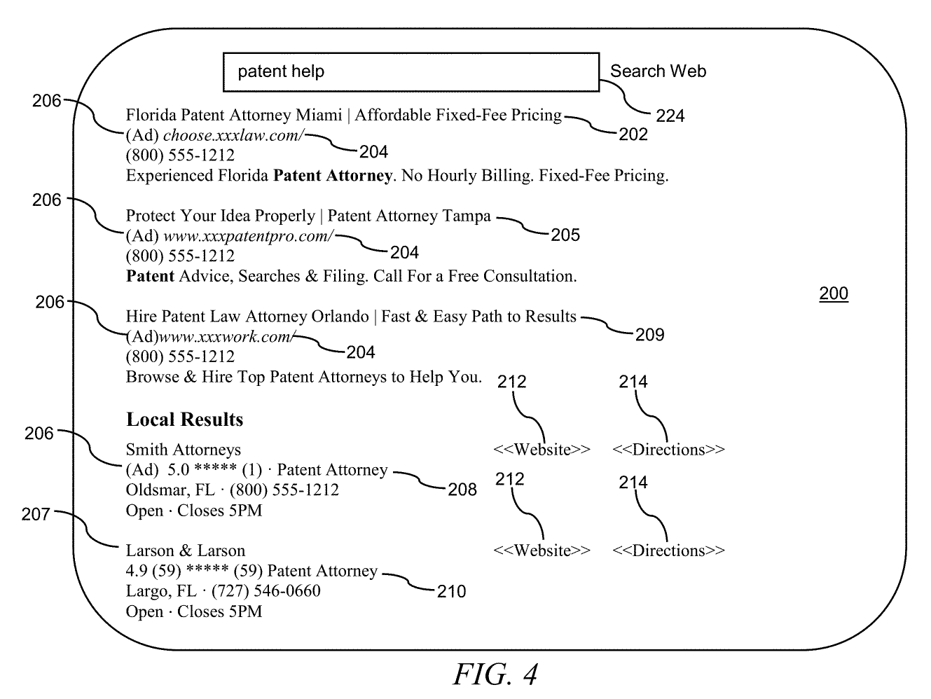

Referring to FIG. 3, a second connected diagram of the system for advertising is shown. In this example, the user device 20 is performing an Internet search. In the exemplary search results 200 shown in FIG. 4, the user has searched for “patent help,” and several results 206 were returned. The search results are provided by a search server 140 (e.g. a search engine) that has access to a searching database 142, for providing results and answers to users making searches. Many such search engines obtain money by advertising. In FIG. 3, the search server 140 consults the search advertisement server 150 before sending search results to the user device 20. The search advertisement server 150 receives content from a store of advertisements 52 (e.g. a database of advertisements, a remote server having advertisements . . . ). The advertisements 52 are provided by marketing companies and each time this advertisement 52 is presented to a user device 20 (e.g. an impression), the search advertisement server 150 bills for the impression by, for example, writing an entry into an accounting and billing file 58. Further, if a user at the user device 20 reads the search results 200 and selects one of the search advertisements 206 (e.g. clicks on the advertisement, taps on the advertisement . . . known as a click-through), in some embodiments, additional bill is written to the accounting and billing file. In this, the marketing company pays additionally when the user visits their web site as a result of the advertisement 206.

In the pasts, various algorithms were used to determine which search advertisement(s) 206 to present in the search results 200. In some prior systems, data on the user device 20 or browsing history of the user was used to improve selection of search advertisements 206.

In the present invention, the search advertisement server 150 consults marketing campaigns 54 and one or more data sources 70 to prioritize the selection of the advertisements.

It is known that placement of results search advertisements 206 in search results 200 depend upon several factors. For example, keywords that are used, bidding by marketing companies, etc. In the example of FIG. 4, several search advertisements 206 are returned, including one from Miami 202 and one from Orlando 208, even though the user is in Tampa. This is because the marketing campaign 54 for the respective firms indicated they would pay more money each time their search advertisement 206 is presented. Therefore, the firm in Miami 202 likely pays more per impression than the other firms and, therefore, appears at the top of the search results 200. Now, the present invention adds the ability of these marketing campaigns 54 to vary the bids for impressions related to certain search keywords. For example, an airline that has direct flights from Chicago to Aruba, a marketing campaign 54 has a directive to bid $0.00001 per impression, but if the temperature in Chicago is below 40 degrees or below 45 degrees and cloudy, the directive changes to bid $0.0005 per impression (increases priority). Therefore, is a user is searching for flights or airlines on a warm sunny day, that airline might show up 10^{th} in the search results 200, but on a cold cloudy day, that airline might show up first or second in the search results 200.

Referring to FIG. 4, a form of advertising in an exemplary search result 200 is shown. In this search result 200, the user has searched 224 the web for “patent help.” The results shown include four advertisement links 206 and one non-advertisement link 207. The primary difference between an advertisement link 206 and a non-advertisement link 207 is that someone paid money to have the advertisement links 206 appear in the search results 200 and such are marked in some way to indicate that they are advertisements. The first three advertisement links 206 appear based upon an order determined by, for example, the amount bid by each advertiser, as the first 202 advertisement link 206 is in Miami, the second 205 is somewhat local, in Tampa, and the third 200 is in Orlando. The first three advertisement links 206 include web addresses (URLs) 204. Clicking on any of the links 206/207 results in the user device 20 being redirected to a web page of the advertiser.

Under “Local Results” an advertisement link 206 and a non-advertisement link 207 are present. Both links 206/207 are expected results of the search term 224 as the context of the search is the locality of the user computer 20, but the order of the links 206/207 is further honed by marketing payments by the advertisement link 206. In other words, the advertiser 208 for the first link paid some amount of money to have their advertisement link 206 appear above (or higher) than the non-paying firm 210. Each local result includes a website 212 and directions to the firm's address 214.

Referring to FIG. 5, a form of advertising in an exemplary web page 220 is shown. There are millions of web pages 220, providing content, information, date such as bank account status, etc. In the example of FIG. 5, a simplified web page 220 is shown for a news/data service 222. This simplified web page 220 has content 230/232 that includes some news data 230 and some recent stock quotations 232. The content 230/232 is typically what the user seeks when browsing to such a page, for example, to see how their stocks are doing or see what is happening in the world. Each time such a web page is accessed, a web page advertisement 226 is included with the data displayed by the user's browser. The web page advertisement 226 is selected by the advertising server 50 based upon various conditions. In the present invention, selection of the web page advertisement 226 is based upon a priority calculated based upon marketing campaigns 54 and data from one or more data sources 70. In a very simplified example, a marketing campaign 54 includes “present advertisement A-001 only when the temperature in Chicago is below 40 degrees.” In such, if the advertising server 50 is ready to display this advertisement A-001, a check on a data source 70 (e.g. a weather service) is used to determine the temperature in Chicago, and if it is below 40 degrees, then the advertisements A-001 is included in the web page 220 (higher priority).

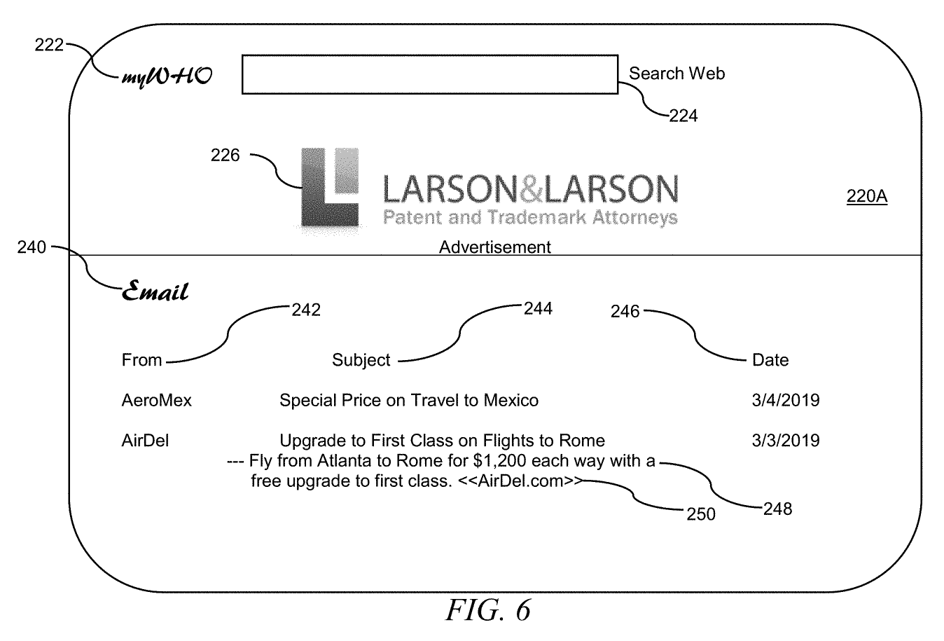

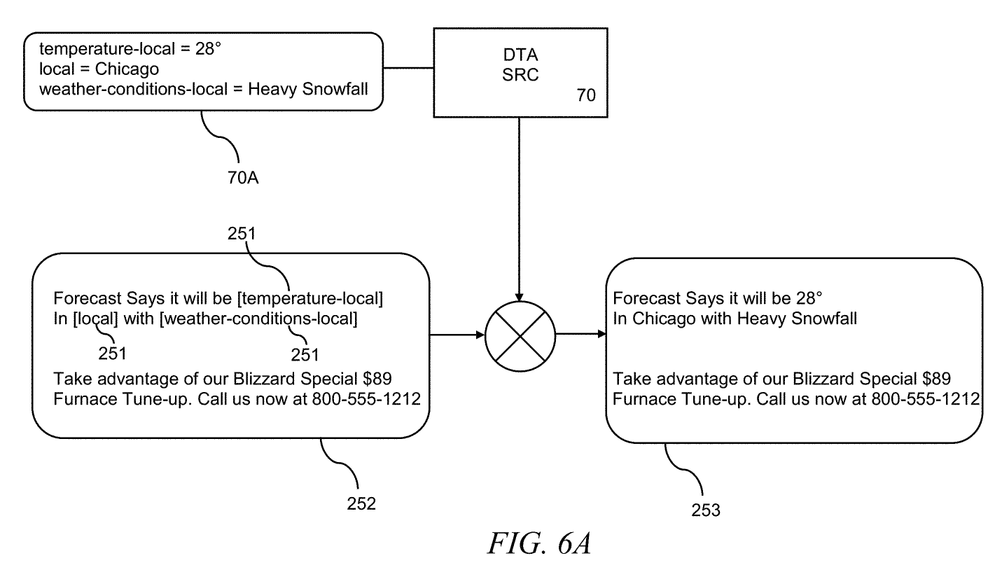

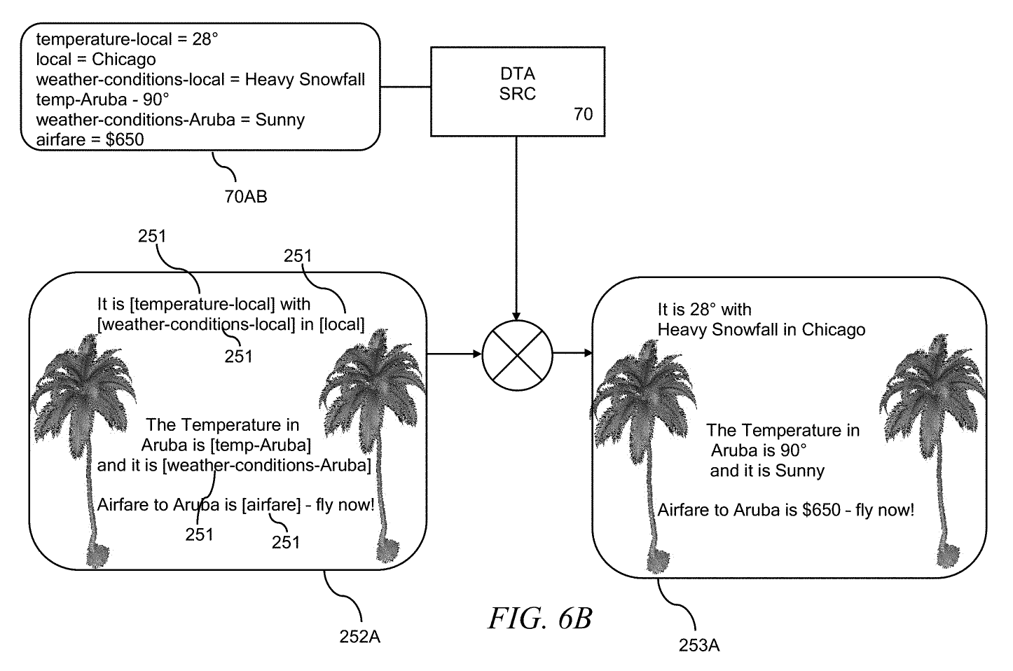

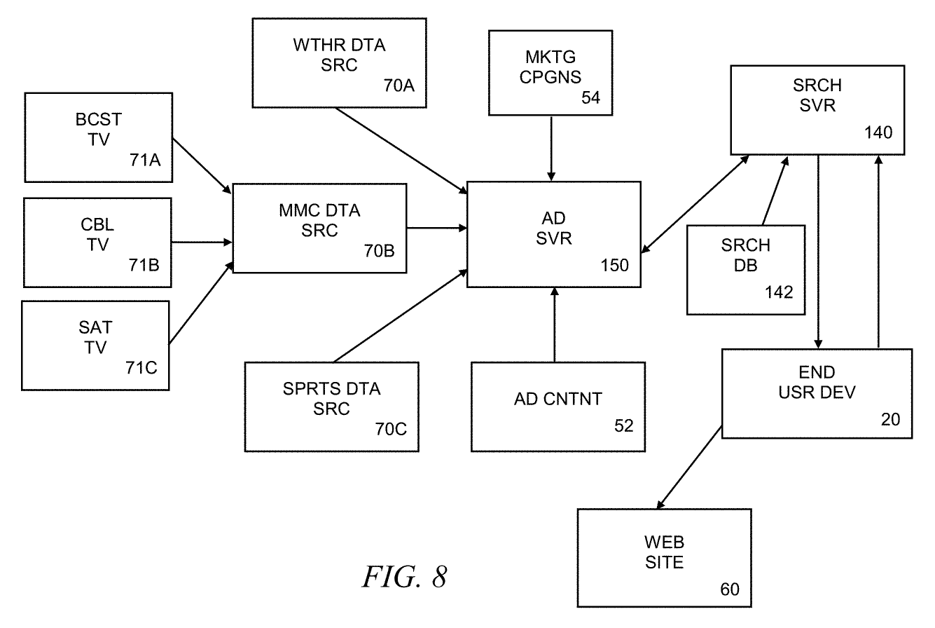

Referring to FIG. 6, a form of advertising in an exemplary message is shown. In the example of FIG. 6, a web page 220A for reading email messages 240 is shown. This web page 220 includes headings and columns for who the message is from 242, the subject of each message 244, and the date each message is received 246. Each time such a web page 220A is accessed, a web page advertisement 226 is included with the data displayed by the user's browser as discussed with FIG. 5. As shown in the second email message 248, an email message has been received from AirDel indicating a price for flights from Atlanta to Rome and a link to the airline 250. Note that marketing companies realize that there is an optimal frequency for sending such messages. If too many messages are sent, the recipient either ignores them or unsubscribes. Therefore, if it is snowing in Rome or the flight price is over $1800, a lower priority for this message is calculated, as it would be assumed that the recipient might ignore an email advertising flights to Rome. Therefore, before sending such messages by an advertising server 50, the advertising server 50 retrieves weather data for Rome from the data sources 70 (e.g. a weather service) and retrieves flight pricing from another data sources 70 (e.g. an airline server) to determine if it is snowing in Rome or if the cost of the flight will be greater than $1800. If it is snowing in Rome or if the cost of the flight will be greater than $1800, a lower priority is calculated and the advertising server 50 does not sent the email message 248 (or text message, etc.). In the example shown in FIG. 8, it must not be snowing in Rome the cost of the flight is less than $1800, at $1200.

Referring to FIG. 6A, a source advertisement 252 is being merged with current dynamic data 70A (e.g. weather data). In this embodiment, the source advertisement 252 has one or more variables 251 that are placed within, for example, text of the source advertisement 252, in the example, as keywords such as [temperature-local]. Any number and type of such variables 251 are anticipated; corresponding to any dynamic data from any data source 70. At any time, for example, when the source advertisement 252 is to be presented or periodically during the day, the data source 70 is accessed to obtain the variables 251 that are present in the source advertisements 252, in this example, the variables are temperature-local, local, and weather-conditions-local which currently are as shown in the current dynamic data 70A. The current dynamic data 70A is then used to replace the variables 251 in the source advertisement 252 with the actual current dynamic data 70A to create the populated advertisement 253 that is eventually presented. Note that the populated advertisement 253 has the variables 251 replaced with the current dynamic data 70A.

Referring to FIG. 6B, a second source advertisement 252A is being merged with weather data and airfare from a second dynamic data source 70AB. In this embodiment, the source advertisement 252A has one or more variables 251 that are placed within, for example, text of the source advertisement 252A; in the example, as keywords such as [temperature-local]. Any number and type of such variables 251 are anticipated, corresponding to any dynamic data from any data source 70. At any time, for example, when the source advertisement 252A is to be presented or periodically during the day, the data source 70 is accessed to obtain the variables 251 that are present in the source advertisements 252A, in this example, the variables are temperature-local, local, weather-conditions-local, temperature-Aruba, weather-conditions-Aruba, and airfare which currently are as shown in the second dynamic data source 70AB. The second dynamic data source 70AB is then used to replace the variables 251 in the source advertisement 252A with data from the second dynamic data source 70AB (e.g. temperatures, weather, airfare) to create the populated advertisement 253A that is eventually presented. Note that the populated advertisement 253A has the variables 251 replaced with dynamic data from the second dynamic data source 70AB.

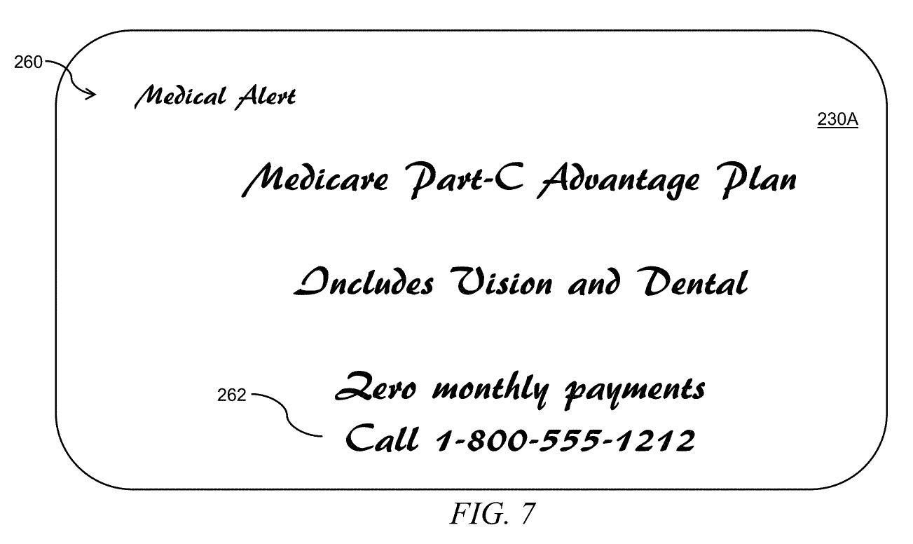

Referring to FIG. 7, a form of advertising 230A in an exemplary television/video program is shown. In television, generally, content is presented (e.g. news program, movie, show, other type of presentation . . . ) intermixed with advertising segments. As video is not easy to show in text, a flat version of this form of advertisement 230A is shown instead. This form of advertisement 230A is an example of an advertisement shown on television between or intermixed in content. In such, the advertising server 50 selects which advertisements to display within a given time slot based upon a marketing campaign 54. For example, an insurance company has arranged for five, 30 second time slots during a famous television game show. Having those time slots, the advertising server 50 determines which advertisements to display based upon a marketing campaign 54. For example, during the months of November and December, select an advertisement for a Medicare advantage form of advertising 230A, but during other months, select an advertisement for life insurance instead. In another example, if it raining, present an advertisement for home roofing products, as homeowners often discover leaking roofs during rain, but if it is sunny, present advertisements for lawn care products.

Referring to FIG. 8, a connected diagram of the system for advertising with multiple data sources 70 is shown. In this example, the user device 20 is performing an Internet search. In the exemplary search results 200 shown in FIG. 4, the user has searched for “patent help,” and several results 206 were returned. The search results are provided by a search server 140 (e.g. a search engine) that has access to a searching database 142, for providing results and answers to users making searches. Many such search engines obtain money by advertising. In FIG. 8, the search server 140 consults the search advertisement server 150 before sending search results to the user device 20. The search advertisement server 150 receives content from a store of advertisement 52 (e.g. a database of advertisements, a remote server having advertisements . . . ). The advertisements 52 are provided, for example, by marketing companies.

In this example, the user device 20 is accessing content, for example, viewing a web page such as the web page 220 shown in FIG. 5, though this scenario is intended to show any type of advertising content and insertion mechanism. The web page 220 is provided by a web site 60, for example, from a news service, a weather service, a sports data source 70C, a media marketing data source 70B, etc. Many such web sites providers obtain money by advertising.

In FIG. 8, the content from the web site 60 is mixed with one or more web page advertisements 126 that are provided from an advertising server 50. The advertising server 50 receives content from a store of advertisements 52 (e.g. a database of advertisements, a remote server having advertisements . . . ). These advertisements 52 are provided by marketing companies If a user at the user device 20 reads the web page advertisements 226 and selects the web page advertisements 226 (e.g. clicks on the advertisement, taps on the advertisement . . . known as a click-through), the browser running on the user device 20 is redirected to a web site 60 of the advertiser.

As discussed above, the advertising server 50 consults marketing campaigns 54 and one or more data sources 70 to aid in the selection of the advertisements. In this example, the data sources 70 include a current dynamic data 70A for weather, a sports data source 70C and a media monitoring data source 70B. The ability to adjust a marketing campaign to benefit from traffic created by television content is described here. As television programs air (broadcast television 71A, cable television 71B, satellite television 71C, internet television, etc.), each program on each channel presents some form of content or advertisement. For example, a cable television show airs a travel program on visiting Italy. The media monitoring data source 70B monitors one, many, or all television programs looking for specific keywords, mentions, voices, programs, actors, locations, etc.

In this example, the media monitoring data source 70B monitors all channels and reports mentions of travel and Italy in the same show. Now, at 2:00 PM, it is found that a travel program on Italy is airing on TV channel 5. Having such knowledge, a travel marketing company has a marketing campaign 54 that says: if a program airs with the words “travel” and “Italy,” then after the program ends, increase the bid for search terms, “Italy,” “Rome,” and “Tuscany” to $0.001. In this way, after the viewers are finished watching the travel program, some will be more likely to find out how much it costs to vacation in Italy and, having knowledge of the travel program, this travel marketing company is able to increase what will be paid to have the search results for locations in Italy include the travel marketing company's advertisement appear on the first page, preferably as the first search result.

In the example discussed with FIG. 3, the media monitoring data source 70B monitors all channels and reports mentions of a competitor's pizza. After there is an advertisement for the competitor's pizza, the marketing campaign has a marketing campaign 54 that increase a frequency of advertisements for that company's pizza chain for fifteen minutes after the competitor's advertisement. Therefore, as people are watching the commercial of the competitor, these people go to their browser to lookup a local establishment of the competitor. These people see a link to the competitor, but now also see an advertisement from the marketing campaign 54 and, statistically, some of those people will select the advertisement, possibly because there are better terms (e.g. two pepperoni pizzas for $10 instead of one pepperoni pizza for $7).

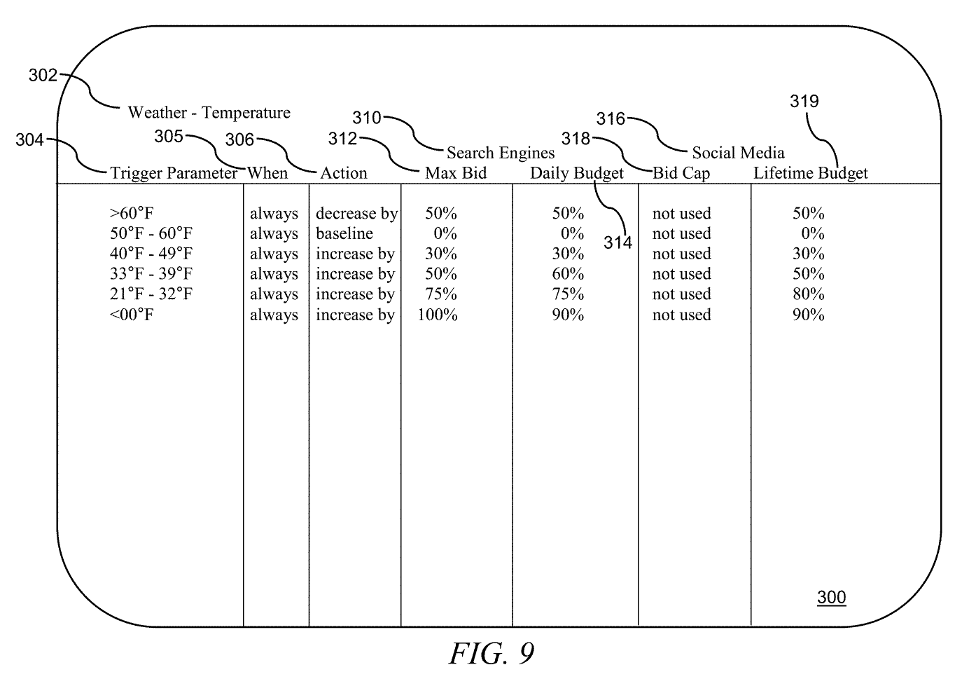

Referring to FIG. 9, a sample weather-related marketing campaign 300 of the system for advertising is shown. This is a marketing campaign 54 based solely on the weather 302, or more precisely, the temperature. As discussed, marketing campaigns 54 are used in the system for advertising to control marketing expenses and target campaigns to ideal times for advertising the advertiser's products and/or services. In the example of FIG. 9, the dynamic data that is used to alter the marketing campaign 54 is weather 302. In this example, a product or service being marketed serves or is more useful in colder temperatures, for example, a sweater, a coat, a space heater, etc.

In the weather-related marketing campaign 300, there are trigger parameters 304 (e.g. range of temperatures); a timing parameter 305 (e.g. always, only on weekends, M/T/T/F); an action 306 (e.g. increase or decrease marketing); controls for search engine advertising 310 including a maximum bid 312 and a daily budget 314; and controls for social media advertising 316 including a bid cap 318 and a lifetime budget 319. The current temperature is the trigger parameter 304 that drives the actions in this weather-related marketing campaign 300. For example, if the current temperature is above 60° F., a lower priority is calculated; and the maximum bid 312 and daily budget 314 for search engine advertising 310 are both reduced by 50%.

Many search engines provide bidding features that advertisers utilize to have their advertisements appear as part of search results. For example, if one advertiser bids $0.0001 per click-through for their sweater and another advertiser bids $0.002 per click-through for their sweater, the second advertiser's search result will likely be included in search results for “sweaters” above the ads of the first advertiser. The maximum bid 312 controls these bids (e.g. the maximum that the advertiser is willing to pay per click-through on search results for a certain keyword or search phrase). The daily budget 314 limits the amount spent for click-throughs during a 24-hour period.

In a similar way, many social networking sites have ways to dynamically change how often an advertisement appears on any social network user's pages. The social media section 316 includes bid caps 318 (not used in this example) and a lifetime budget 319. The bid caps 318 are similar to the maximum bid 312, but for social media. The lifetime budgets 319 are similar to the daily budget 314, for social media, but typically set limits for the entire marketing campaign 54 (e.g. for a week, two weeks, a month . . . ).

In this weather-related marketing campaign 300, when the temperature is above 60° F., the maximum bid 312 is reduced by 50% and the daily budget 314 is reduced by 50%; therefore, the related advertisement will appear less frequently when a particular keyword (e.g. “sweater”) is used in a search. Likewise, the lifetime budget 319 is reduced by 50%, thereby reducing the number of impressions in social media. Now, when the temperature drops these advertising budgets increase from a baseline when the temperature is 50° F. to 60° F., increasing more until a maximum advertising budget is expended when the temperature is below 0° F. where the maximum bid 312 is increased by 100% and the daily budget 314 is increased by 90%; therefore, the related advertisement will appear much more frequently when a particular keyword (e.g. “sweater”) is used in a search. Likewise, the lifetime budget 319 is increased by 90%, thereby increasing the number of impressions in social media.

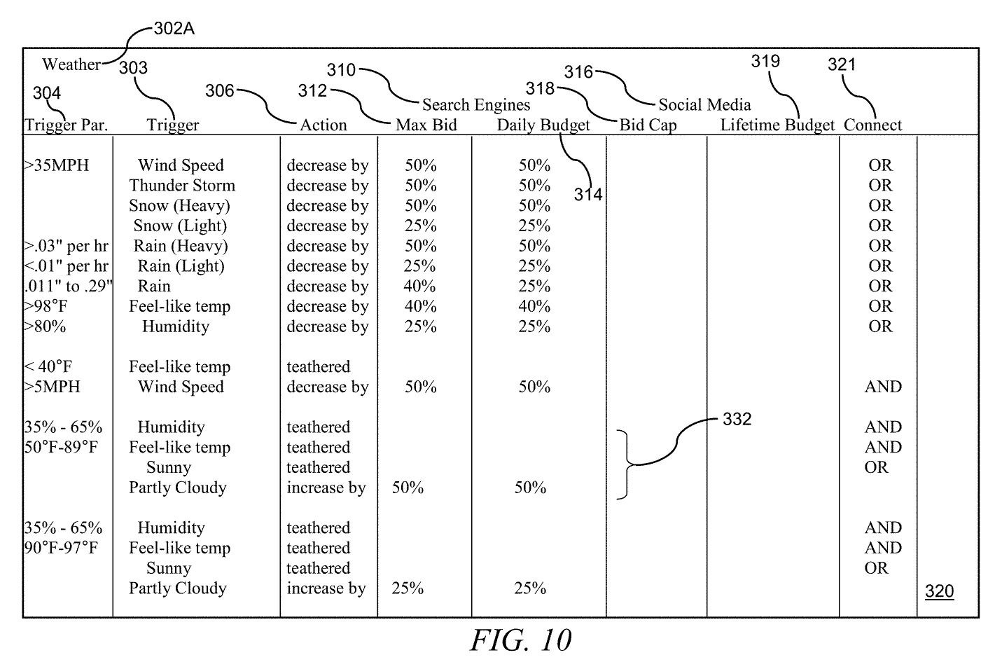

Referring to FIG. 10, a second sample marketing campaign 320 of the system for advertising is shown. The second sample marketing campaign 320 in this example is for products that include, for example, inside the store garden items such as grills, portable outdoor power, pressure washers, chore products (e.g. snow blowers), generators; and outdoor the store garden items such as live goods, planters, fertilizers, soils, and mulch. This is likely for a large home goods store.

This is a marketing campaign 54 is based on the weather 302A, or more precisely, the current temperature, current conditions, and current winds. As discussed, marketing campaigns 54 are used in the system for advertising to control marketing expenses and target campaigns to ideal times for advertising the advertiser's products and/or services. In the example of FIG. 10, the dynamic data that is used to alter the marketing campaign 54 is weather 302.

In this second sample marketing campaign 320, there are trigger parameters 304 (e.g. range of temperatures, wind speeds, rain amounts); a trigger description 303 (e.g. wind speed, feels-like temperature, sunny, cloudy); an action 306 (e.g. increase or decrease marketing); controls for search engine advertising 310 including a maximum bid 312 and a daily budget 314; controls for social media advertising 316 including a bid cap 318 and a lifetime budget 319; and a connector.

The trigger parameter 304 that drives the actions in this second sample marketing campaign 320 is a weather-related current value. For example, if the current wind speed is above 35 MPH, the maximum bid 312 and daily budget 314 for search engine advertising 310 are both reduced by 50%. In this example, there are connectors 321, joining multiple lines of the marketing campaign 54. For example, even if the wind speed isn't above 35 MPH, if there is a thunder storm, the maximum bid 312 and daily budget 314 for search engine advertising 310 are both reduced by 50%. The connector 321 allows for joining multiple conditions such as the set of lines 332 that increase both the maximum bid 312 and daily budget 314 for search engine advertising 310 by 50% if the humidity is between 35% and 65%, and the feels-like temperature is between 50° F. and 89° F. and it is either sunny or partly cloudy. In other words, when it is pleasant outside, the marketing budget for the above noted products is increased. Note that it is anticipated that each set of lines in the marketing campaign 54 represent the same set or a different set of products as noted above. For example, the products advertised when it is pleasant outside excludes snow blowers and the products advertised when it is cold outside excludes grills, live goods, planters, fertilizers, soils, and mulch.

In this second sample marketing campaign 320, when the humidity is between 35% and 65%, the temperature is between 90° F.-97° F. and it is either sunny or partly cloudy, the maximum bid 312 is increased by 25% and the daily budget 314 is increased by 25%; therefore, the related advertisement will appear more frequently when a particular keyword (e.g. “fertilizer”) is used in a search.

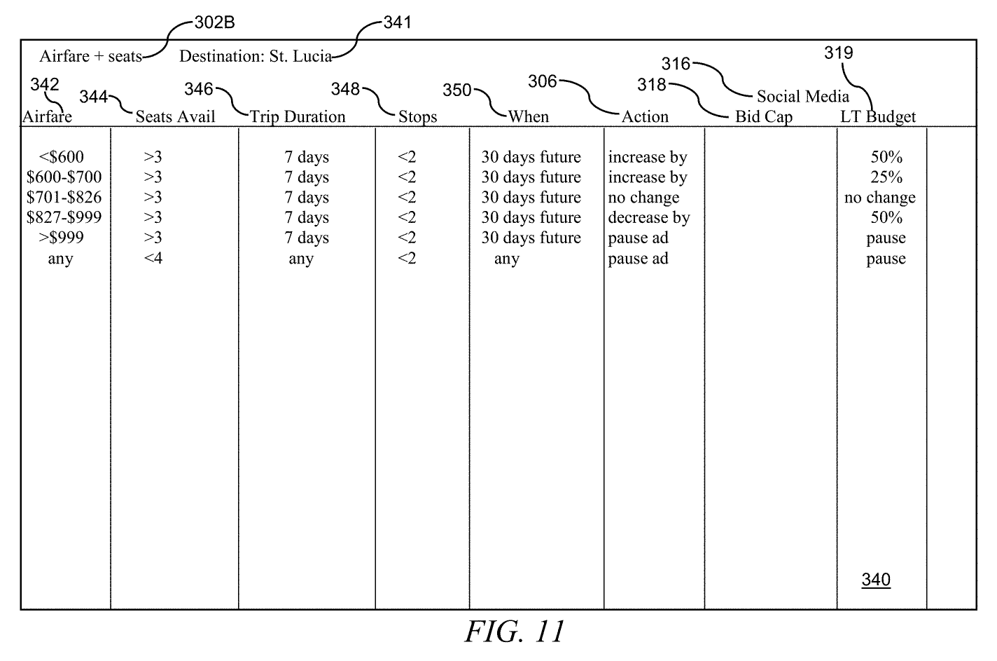

Referring to FIG. 11, a third sample marketing campaign 340 of the system for advertising is shown. The third sample marketing campaign 340 in this example is for products that expire after a certain date, for example, airline seats. Once a flight departs; the value of empty airline seats on the flight approaches zero.

This is a marketing campaign 54 is based on two things, airfares and seat availability (as well as other travel-related parameters). The basic concept from the perspective of, for example, the St. Lucia tourism board, is that, when prices are low and seats are available, advertising is more valuable than when prices are high or there are no seats. In other words, why advertise, when there are no airline seats available (or no hotel rooms available, etc.). Therefore, the third sample marketing campaign 340 is used in the system for advertising to control marketing expenses and target campaigns to ideal times for advertising when airfares and seat availability are best to attract visitors. In the example of FIG. 11, the dynamic data that is used to alter the marketing campaign 54 is airfare 342 and seat availability 344. Secondary consideration is trip duration 346 (e.g. 7 days), number of stops 348 (e.g. <2) and when the trip will be made 350 (e.g. 30 days from now). Note that this list is not limiting. For example, another consideration in increasing/decreasing advertising budget is weather at the departure location and at the destination location (e.g. St. Lucia). If it is lower than 40° F. at the departure location and higher than 85° F. in St. Lucia, the budget is increased as more people will be looking to escape from the departure location. On the other hand, if it is higher than 60° F. at the departure location and raining in St. Lucia, the budget is decreased as less people will be looking to escape from the departure location when the weather at the departure location isn't too bad.

In this third sample marketing campaign 340, the primary triggers are airfare 342 and seat availability 344. In this example, there are only controls for social media advertising 316 including a bid cap 318 and a lifetime budget 319.

In this third marketing campaign 340, when airfare is low (<$600), the lifetime budget 319 is increased by 50%; therefore, the advertisement for travel to St. Lucia will appear more frequently for social media users. As the airfare increases (e.g. to between $600 and $700), the lifetime budget 319 is increased by less (25%); therefore, the advertisement for travel to St. Lucia will appear less frequently for social media users. If the airfare increases too much (e.g. over $999), the lifetime budget 319 is paused; therefore, the advertisement for travel to St. Lucia will not appear to social media users. In addition, independent of the airfare, if the number of airline seats available is 3 or less, the lifetime budget 319 is also paused; therefore, the advertisement for travel to St. Lucia will not appear to social media users.

Note that it is fully anticipated that, having the dynamic data used to drive the advertising budgets and other dynamic data, in some embodiments, such dynamic data is also inserted into the advertisements. For example, “Flights to St. Lucia are available for under $600 and it is currently 87 degrees in St. Lucia,” or, “It is 33 degrees in Chicago today, but 89 degrees in St. Lucia; airfares are as low as $700 and there are at least 4 seats available for your getaway.”

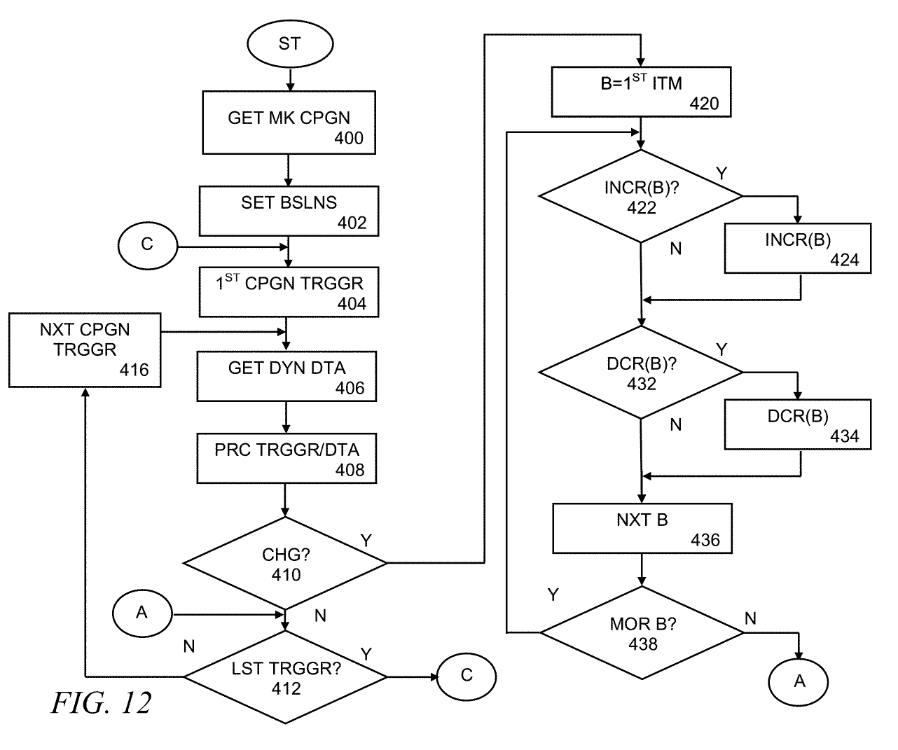

Referring to FIG. 12, a sample program flow of the system for advertising is shown. There are countless ways to represent marketing campaigns 54 including tables (as shown in FIGS. 9-11), scripting languages, databases, etc. Likewise, there are countless ways to program a computer system to interpret such marketing campaigns 54, to obtain the dynamic data, and to adjust marketing budgets, bids, placement, advertisement selections, etc., responsive to the dynamic data. For clarity reasons, this explanation describes the program flow with respect to increasing/decreasing parameters such as a search engine bid for a specific keyword (or set of keywords) or a frequency of a particular advertisement displayed, for example, on social media.

The example shown in FIG. 12 begins with retrieving 400 a marketing campaign 54 and setting values 402 to a baseline value based upon the marketing campaign 54 (e.g. setting the baseline search engine bid to $0.0005). As discussed above, there are one or more triggers that are used to adjust the values up or down.

The first such trigger (e.g. temperature>40° F., >2 seats available, airfare<$600, team X won last night, shark week on television . . . ) is retrieved 404 and a loop begins. In the loop, the dynamic data is retrieved 406 (e.g. weather data, sporting event data, seat availability, flight costs, television show listings) and processed 408 against the trigger to determine a priority. If the processing 408 indicates 410 no values need to be adjusted, then if this was the last 412 trigger, the program loops at the first such trigger is selected 404. If the processing 408 indicates 410 no values need to be adjusted, then if this was not the last 412 trigger, the next trigger is selected 416 and the loop continues (A).

If the processing 408 indicates 410 that one or more values need to be adjusted (e.g. a higher or lower priority), the current value to be adjusted (b) is set 420 to the first value to be adjusted. A loop begins by determining if the current value needs to be increased 422 (e.g., a higher priority), and if so, the first value is increased 424 (e.g. increase the search engine bid to 20% over the baseline or to $0.0006 in the example above). Next, it is determined if the current value needs to be decreased 432 (e.g., a lower priority), and if so, the first value is increased 434 (e.g. decrease the search engine bid to −40% over the baseline or to $0.0003 in the example above). Now the next value to be adjusted is selected 436 and if there are more values to be adjusted 438, the loop continues (422), otherwise the next campaign trigger is processed (A).

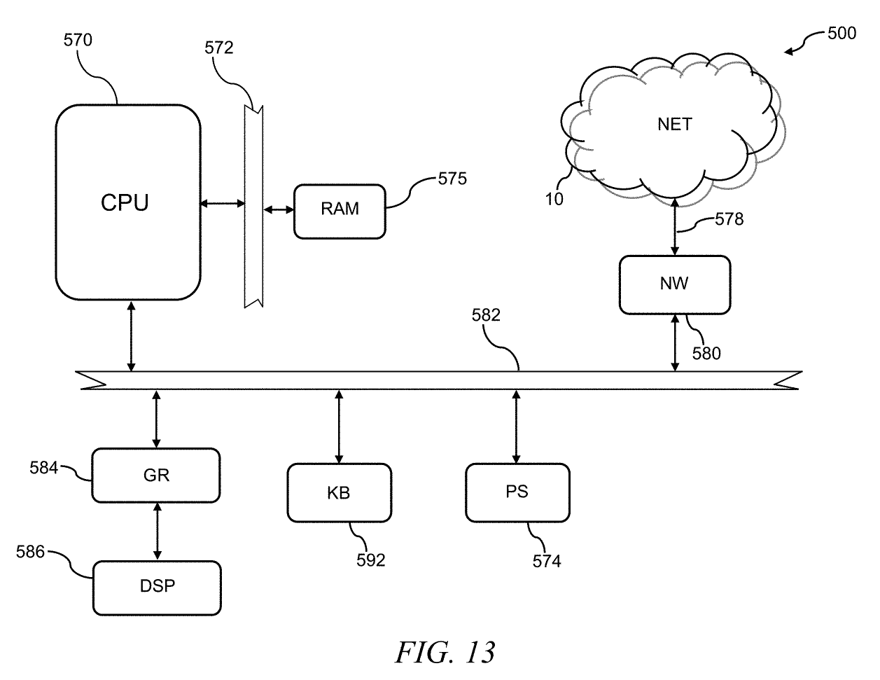

Referring to FIG. 13, a schematic of a typical computer system as used by the system for advertising is shown. The example typical computer system 500 represents a typical device used as in the system for advertising. This typical computer system 500 is shown in its simplest form. Different architectures are known that accomplish similar results in a similar fashion and the present invention is not limited in any way to any particular computer system architecture or implementation. In this exemplary computer system, a processor 570 executes or runs programs in a random access memory 575. The programs are generally stored within a persistent memory 574 and loaded into the random access memory 575 when needed. The processor 570 is any processor, typically a processor designed for computer systems with any number of core processing elements, etc. The random access memory 575 is connected to the processor by, for example, a memory bus 572. The random access memory 575 is any memory suitable for connection and operation with the selected processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, magnetic memory, etc. The persistent memory 574 is typically interfaced to the processor 570 through a system bus 582, or any other interface as known in the industry.

Also shown connected to the system bus 582 is a network interface 580 (e.g., for connecting to a network 10), a graphics adapter 584 and a keyboard interface 592 (e.g., Universal Serial Bus—USB). The graphics adapter 584 receives information from the processor 570 and controls what is depicted on a display 586. The keyboard interface 592 provides navigation, data entry, and selection features.

In general, some portion of the persistent memory 574 is used to store programs, executable code, data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An advertising system comprising:
at least one source of dynamic data;
an advertisement;
software running on a processor receives the dynamic data from the at least one source of dynamic data and analyzes the dynamic data as related to the advertisement and determines a priority; and
the software then controls placement of the advertisement based upon the priority.

2. The advertising system of claim 1, wherein if the priority is zero, the software suppresses placement of the advertisement.

3. The advertising system of claim 1, wherein the software controls a bid for placement of the advertisement based upon the priority, the software increases the bid as the priority increases and decreases the bid as the priority decreases.

4. The advertising system of claim 3, wherein the bid is a maximum bid for a search engine.

5. The advertising system of claim 3, wherein the bid is for presenting the advertisement on a social media service.

6. The advertising system of claim 1, wherein the software controls a budget for placement of the advertisement based upon the priority, the software increases the budget as the priority increases and decreases the budget as the priority decreases.

7. The advertising system of claim 6, wherein the budget is a daily budget for a search engine.

8. The advertising system of claim 6, wherein the budget is a maximum lifetime budget for presenting the advertisement on a social media service.

9. The advertising system of claim 1, further comprising the software modifies the advertisement using at least one data item from the dynamic data.

10. A method of advertising comprising:
receiving dynamic data from a data source;
determining a priority based upon the dynamic data and a marketing campaign; and
adjusting a frequency of presentation of an advertisement based upon the priority.

11. The method of claim 10, wherein the step of adjusting the frequency of presentation of the advertisement comprises increasing or decreasing a bid for placement of the advertisement.

12. The method of claim 10, wherein the step of adjusting the frequency of presentation of the advertisement comprises increasing or decreasing a budget limit for placement of the advertisement.

13. The method of claim 10, wherein the dynamic data comprises at least two data items selected from the group consisting of airline seat availability, cost per seat, hotel occupancy, weather, and scheduled television programs.

14. The method of claim 10, further comprising a step of modifying the advertisement based upon the dynamic data.

15. The method of claim 10, further comprising the steps of:
detecting airing of a complimentary advertisement on broadcast media; and
upon the detecting of the complimentary advertisement on the broadcast media, increasing the frequency of the advertisement for a predetermined period of time.

16. Program instructions tangibly embodied in a non-transitory storage medium comprising at least one instruction configured to implement a system for advertising, wherein the at least one instruction comprises:
computer readable instructions executed by a processor of a computer causing the computer to request dynamic data from at least one data source over a communications network;
computer readable instructions executed by the processor causing the computer to calculate a priority based upon the dynamic data;
computer readable instructions executed by the processor causing the computer to control a frequency of presentation of an advertisement based upon the priority.

17. The program instructions tangibly embodied in the non-transitory storage medium of claim 16, wherein the computer readable instructions executed by the processor causing the computer to control the frequency of presentation of the advertisement based upon the priority control the frequency of presentation of the advertisement by controlling a bid for placement of the advertisement.

18. The program instructions tangibly embodied in the non-transitory storage medium of claim 16, wherein the computer readable instructions executed by the processor causing the computer to control the frequency of presentation of the advertisement based upon the priority control the frequency of presentation of the advertisement by controlling a budget for placement of the advertisement.

19. The program instructions tangibly embodied in the non-transitory storage medium of claim 17, wherein the bid for placement of the advertisement is a search engine bid.

20. The program instructions tangibly embodied in the non-transitory storage medium of claim 16, further comprising computer readable instructions executed by the processor causing the computer to modify the advertisement based upon the dynamic data.
